(19) United States
(12) Patent Application Publication
(10) Pub. No.: US 2024/0271737 A1
(43) Pub. Date: Aug. 15, 2024

(54) REPAIR BOOT FOR AN AIR INTAKE ASSEMBLY

(71) Applicant: RB Distribution, Inc., Colmar, PA (US)

(72) Inventors: Christopher Thomas Van Osten, Telford, PA (US); Sagar Kumar, Bensalem, PA (US); Marc Anthony McCann, Philadelphia, PA (US)

(73) Assignee: RB Distribution, Inc., Colmar, PA (US)

(21) Appl. No.: 18/169,663

(22) Filed: Feb. 15, 2023

(51) Int. Cl. F16L 55/16; F02M 35/10; F16L 33/23

(52) U.S. Cl. CPC F16L 55/1608; F02M 35/10137; F16L 33/23

(57) ABSTRACT

A repair boot for an air intake assembly having an air intake duct. The repair boot is open between its ends and has a collar with a first interior dimension that is selected to complement the air intake duct and a second interior diameter that is selected to engage a surrounding flange on the exterior of air intake duct.

### FIELD OF INVENTION

The present invention relates generally to air intake assemblies that are associated with internal combustion engines. More particularly, the invention relates to air intake assemblies that need repairs because they are experiencing leaks. Most particularly, the invention relates to air intake assemblies that need repairs because they are experiencing leaks in a flexible tube that is part of the assembly and has been affixed to an air intake tube by a variety of plastic welding techniques, or an adhesive.

### BACKGROUND

Many air intake assemblies, some of which are provided by original equipment manufactures and some of which are provided by aftermarket supplies, have an air intake tube with a boot that is glued on with an adhesive or sonic welded to the air intake tube. Over time, wear factors, such as heat changes and vibrations, cause fatigue in the glue or weld securing the boot and the boot begins to leak. Because it is important to engine power and economy to control the air intake, repairs become necessary. Most commonly, these repairs require the expense of purchasing a new air intake assembly.

### SUMMARY

The present invention provides an alternative to the expensive repair option of a new assembly by providing a new air intake boot that is configured to fit on the existing air intake tube and be secure against leakage.

### BRIEF DESCRIPTION OF THE DRAWINGS

The invention will be more fully understood by reference to the drawings wherein:

FIG. 1 illustrates the repair component in the environment of an exemplary air intake assembly;

FIG. 2 illustrates the repair components assembled on an exemplary air intake assembly;

FIG. 3 is a plan view of the free end of the repair boot on the air intake tube;

FIG. 4 is a section view along the line 4-4 in FIG. 3; and,

FIG. 5 is an exploded view of the encircled area 5 in FIG. 4.

### DETAILED DESCRIPTION

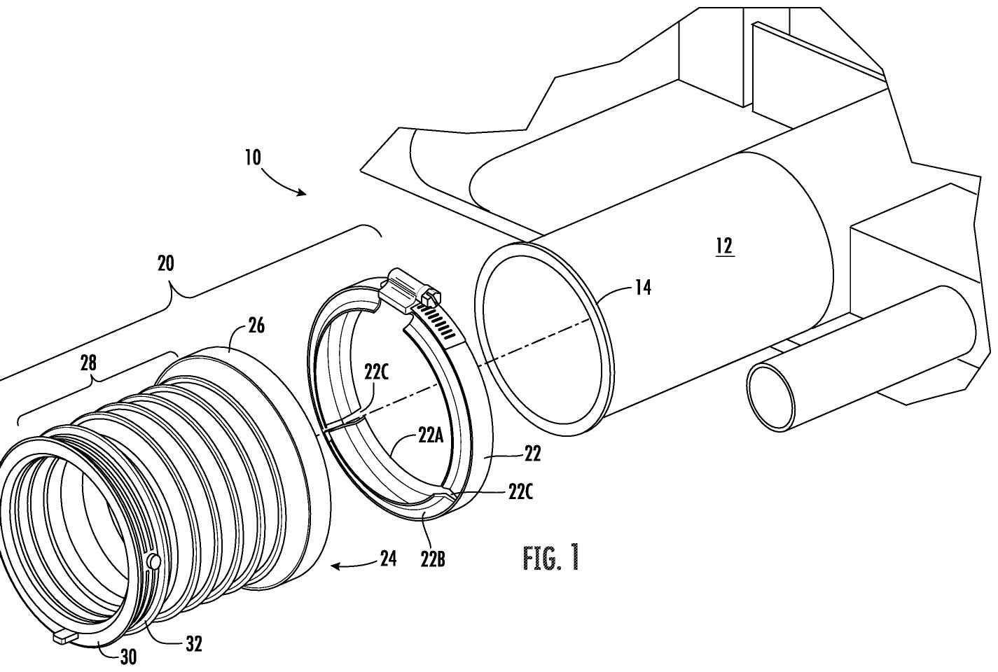

Referring now to the drawings, FIG. 1 illustrates an exploded view of an exemplary air intake module 10 having an intake tube 12 and a circumferential flange 14 at a free end of the intake tube 12. The repair boot, generally designed as 20, includes a clamp 22, and a body 24 that has an end 26 configured to fit over the flange 14 associated with an existing air management system, an intermediate portion 28, and a free end 30 with a clamping area 32 that is configured to connect with another component of an existing air management system that incorporates the air intake module 10. The immediate portion 28 is illustrated as a flexible corrugation or billows; however, intermediate portion 28 may have a fixed shape in some application. The clamp 22 has sides 22A and 22B that fit on either side of the end 26 and reliefs 22C that facilitate uniform closing of the clamp 22.

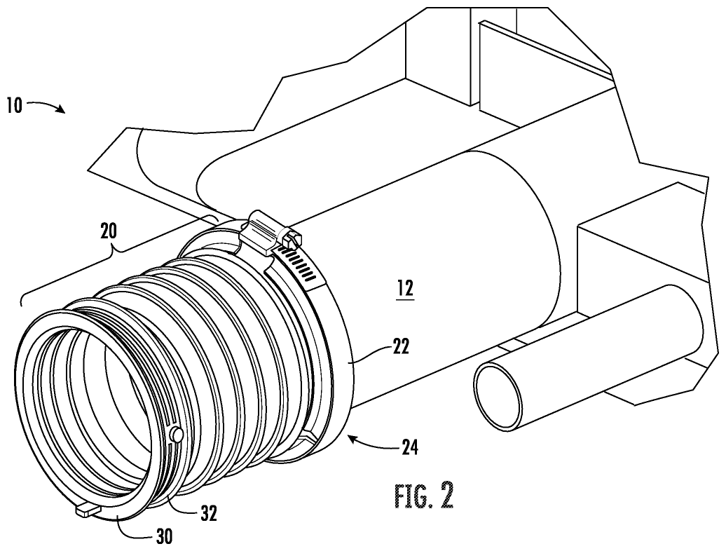

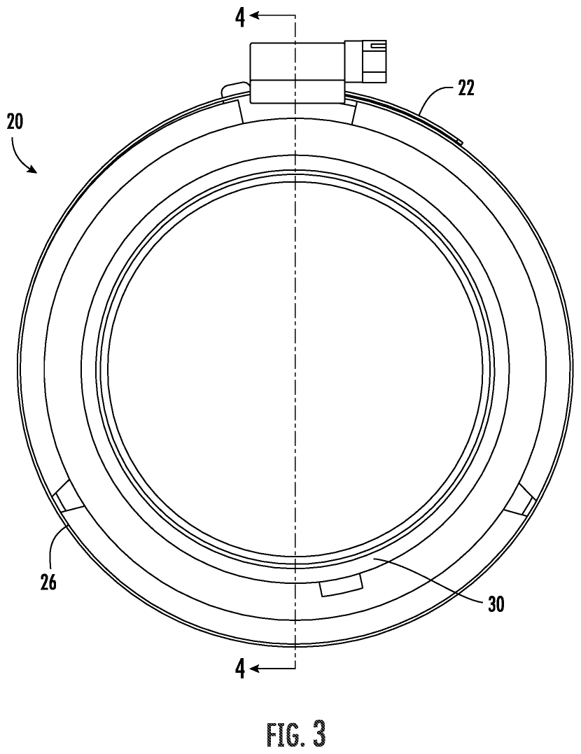

FIG. 2 illustrates the repair parts in FIG. 1 assembled on the flange 14 of FIG. 1 on tube 12. FIG. 3 is a plan view of the free end 30 showing that the intermediate portion 28 in FIG. 1 has an interior diameter that compatible with the diameter of the air intake tube 12 as shown in FIG. 2. This enables the repair part to imitate the original manufacturer equipment so engine performance is not altered or hindered.

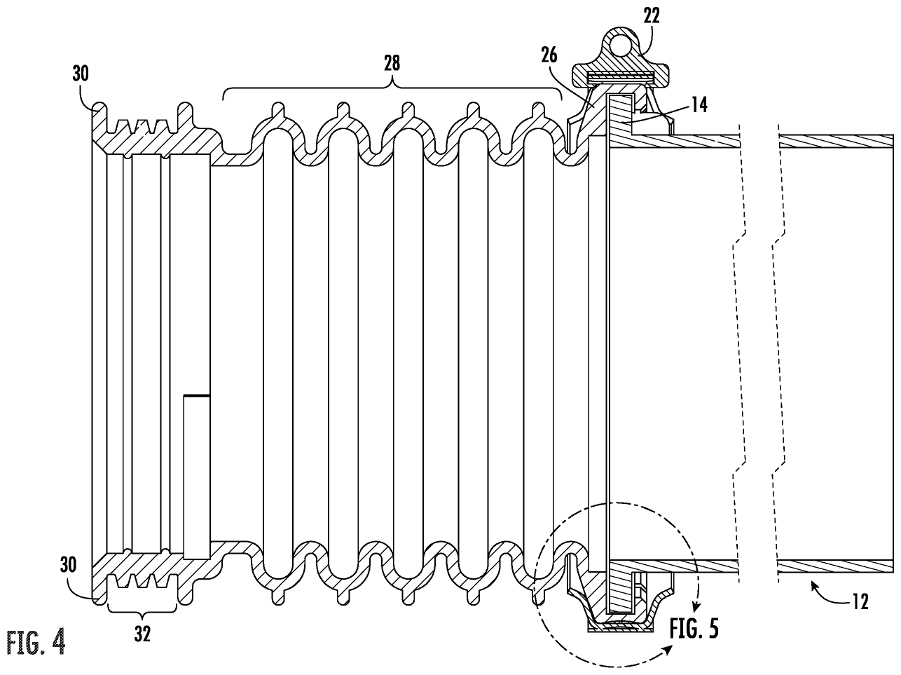

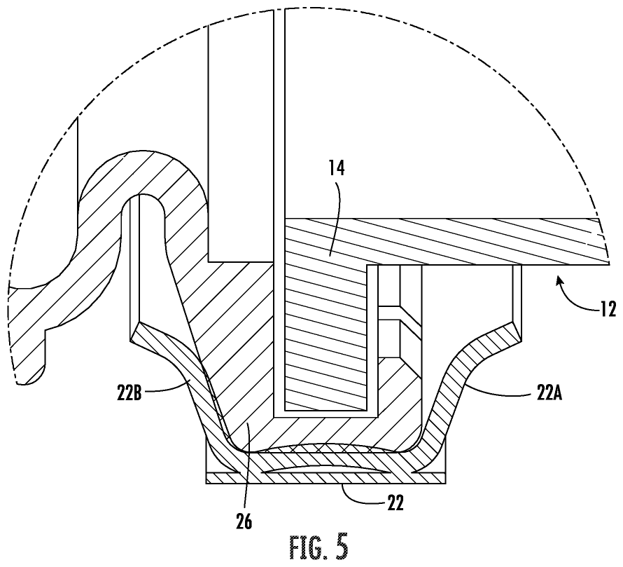

FIG. 4, a section along the line 4-4 in FIG. 3, illustrates the attachment of the end 26 in FIG. 1 over the flange 14 and secured by the clamp 22, and FIG. 5 is an enlargement of that attachment. As shown in FIG. 5, the end 26 has an inverted right angle “U” shape that overlie the flange 14. The distance between the sides of the “U” are sized to receive the flange 14 and contact the intake tube 12. The clamp 22 is closed so that the end 26 is brought into contact with the free end of flange 14 and any expansion of the end 26 is confined within the sides 22A and 22B.

The intermediate portion 28, shown in FIGS. 1, 2, and 4, is formed as a flexible corrugation or billows and is preferable made for material associated with air and fluid transport in an engine compartment that may have elevated temperatures.

In order to install the repair boot, the original boot is removed and any residual sealant or adhesive on the tube 12 or flange 14 is removed and the surface is cleaned with an appropriate solvent. The repair boot may be applied with or without an additional adhesive.

What is claimed is:

1. A repair boot for an air intake assembly having an air intake duct with a free end that includes a surrounding flange, the repair boot comprising:
a flexible body that has an inner diameter between a first end and a second end that is compatible with an inner diameter of a free end; and,
the flexible body has a peripheral collar with a first interior dimension that is selected to complement an outer diameter of with an air intake duct and a second interior diameter that is selected to overlie a surrounding flange on an air intake duct.

2. The repair boot of claim 1, wherein the flexible body has a corrugated configuration.

3. The repair boot of claim 2, wherein the peripheral collar is a non-corrugated portion of the flexible body.

4. The repair boot of claim 1, wherein the peripheral collar is dimensioned to receive a clamp for fixing the peripheral collar to and air intake duct.

5. The repair boot of claim 1, wherein the peripheral collar that overlies a surrounding flange on an air intake duct is “U” shaped.

6. A repair kit for an air intake assembly having an air intake duct with a free end that includes a surrounding flange, the repair kit comprising:
a repair boot having:
an open body having a portion with inner diameter that is selected to complement a predetermined air intake duct free end, a peripheral collar at a first end has a first interior dimension that is selected to complement an outer diameter of an air intake duct and a second interior diameter that is selected to overlie a surrounding flange on an air intake duct, and a second end has a coupling portion that is configured to connect an air intake assembly to an existing air management system; and,
a clamp that is dimensioned to fit over the outer diameter of the peripheral collar and tighten the peripheral collar against a surrounding flange on an air intake duct.

7. The repair kit of claim 6, wherein the open body has a corrugated configuration.

8. The repair kit of claim 7, further comprising a second clamp for fixing the coupling end to an existing air management system.

9. The repair kit of claim 6, wherein the peripheral collar that overlies a surrounding flange on an air intake duct is “U” shaped.

10. The repair kit of claim 6, further comprising a second clamp for fixing the non-corrugated portion to another object.

11. The repair kit of claim 6, wherein the coupling portion has a recess that receives a clamp.

12. The repair kit of claim 11, further comprising a second clamp that fits within the coupling portion recess for fixing the second end to an existing air management system.

13. A repair boot for attachment to an air intake duct in an air management system with a free end, the repair boot comprising:
a body that has an inner diameter between a first end and a second end that is compatible with an inner diameter in a free end on an air intake duct having;
one of the first end and the second end on the body is configured for attachment to a free end of an air intake duct and the other one of the first end and the second end on the body is configured for attachment to another component associated with an existing air management system.

14. The repair boot of claim 13, wherein a portion of the body is flexible.

15. The repair boot of claim 13, wherein a portion of the body has a fixed shape.
